(19) United States
(12) Patent Application Publication
(10) Pub. No.: US 2012/0175938 A1
(43) Pub. Date: Jul. 12, 2012

(54) Roadway Grinding/Cutting Apparatus and Monitoring System

(75) Inventors: Christopher ARCONA, Northborough, MA (US); Douglas A. Wakefield, Worcester, MA (US); Terrence W. Lannom, Lebanon, TN (US)

(73) Assignees: SAINT-GOBAIN ABRASIFS, Conflans-Sainte-Honorine (FR); SAINT-GOBAIN ABRASIVES, INC., Worcester, MA (US)

(21) Appl. No.: 13/280,174

(22) Filed: Oct. 24, 2011

Related U.S. Application Data
(63) Continuation of application No. 11/642,429, filed on Dec. 20, 2006, now abandoned.

(51) Int. Cl. E01C 23/12; G07C 5/08

(52) U.S. Cl. 299/39.4

(57) ABSTRACT

A roadway grinding system is disclosed and can include a frame and a first cutting blade disposed within the frame. The first cutting blade can include a core. Further, a plurality of abrasive segments can be spaced apart from each other on the core. A first sensor can be disposed on the frame and can be configured to detect blade wear as a change in the distance between an outermost circumference of the first cutting blade and a predetermined distance.

### BACKGROUND

1. Technical Field

This invention relates to vehicles equipped with abrasive saw blades for cutting concrete, stone, asphalt and other similar surfaces, and in particular, to a monitoring system mounted on these vehicles for providing in-process feedback to control operation of the saw blades, and to enable analyses of blade performance and the grinding operation.

2. Background Information

The present invention is described below in connection with the concrete industry by way of example only but is equally useful in cutting other hard surfaces. Moreover, the use of diamond abrasive is described by way of example only, with the understanding that as used herein, the term “diamond” or “diamond abrasive” collectively refers to nominally any type of superabrasive, including CBN (cubic boron nitride), PCD (polycrystalline diamond), and single crystal synthetic diamond or natural diamond, with or without metal cladding used to improve grain retention in the finished product.

The resurfacing of highways, bridges and airport runways is a significant application for superabrasive products. The practice of restoring roadways with superabrasive grinding wheels is commonly referred to as “diamond grinding”. Diamond grinding improves both traction and ride smoothness. This technology has been successfully used in the US since about 1965 to extend the life of roadways at a fraction of the cost of conventional concrete overlay techniques.

This roadway grinding is commonly accomplished with custom built machines that support a concentric assembly of blades (thin grinding wheels), each including a metal (e.g., steel) core with metal-bonded superabrasive segments distributed circumferentially thereon. The blades are typically about 14 in (35 cm) in diameter and 0.2 in (0.5 cm) or 0.6 in (1. Scm) wide. On a single arbor (axis), 170-280 blades may be mounted. This assembly is driven by a large diesel engine (300-750 hp) to achieve a typical depth of cut of ⅛ in (0.3 cm) to 1 in (2.5 cm) at a grinding rate of about 15 ft/min (4.6 m/min) over the highway. These grinding systems can run continuously, or with few breaks, for many hours.

The machine typically provides little information to the machine operator regarding the state of the grinding process. Engine rpm and hydraulic pressure applied to the grinding wheels may be displayed to the operator on some machines. The operator primarily relies on such information and visual or audible clues to assess the performance of the machine and the grinding wheel assembly.

The lack of quantitative process measurement and analysis may lead to problems in these superabrasive grinding operations. Small system variations that are unknown to the operator, such as a variation in depth of cut across the length of the grinding wheel assembly axis, or insufficient cooling water supply, can lead to undesirable grinding conditions and premature failure of various components. Other machine related problems, such as failure of the grinding head bearings, may also result in a costly shut-down of grinding operations.

Thus, a need exists for a monitoring system capable of providing an operator of the aforementioned grinding machines with in-process (real-time) information on the state of the on-going grinding operation, for use in maintaining the performance of the grinding system.

### SUMMARY

An aspect of the invention includes an apparatus for monitoring operation of a roadway grinding machine of the type configured to travel along a roadway while engaging and grinding the roadway with a grinding head. A first displacement sensor generates, during the travel, first distance data associated with a distance between a reference level and a location on the roadway ahead of the grinding zone. A second displacement sensor generates, during the travel, second distance data associated with a distance between the reference level and a location on the roadway behind the grinding zone. A processor captures and uses the first and second distance data to determine a depth of cut during grinding operations.

Another aspect of the invention includes an apparatus for grinding concrete roadways. The apparatus includes a ground engaging vehicle configured to travel along the roadway while supporting and driving a grinding head having a plurality of circular blades spaced co-axially along a central axis, each blade having a plurality of superabrasives circumferentially spaced thereon. The grinding head is displaceable to engage and grind the roadway at a grinding zone during the travel. Coolant means supplies coolant to the grinding zone and collects the coolant after use. The apparatus also includes a grinding monitoring system including a first displacement sensor to generate, during the travel, first distance data associated with a distance between a reference level and a location on the roadway ahead of the grinding zone. A second displacement sensor generates, during the travel, second distance data associated with a distance between the reference level and a location on the roadway behind the grinding zone. A third displacement sensor generates third distance data associated with a distance between a circumference of the blades and a predetermined position relative to the axis. A pressure sensor generates, during the travel, pressure data associated with pressure of the coolant. A temperature detector generates, during the travel, temperature data associated with the coolant at a supply location and at a collection location. A vehicle speed sensor generates, during the travel, data associated with speed of travel along the roadway. A vibration sensor generates, during the travel, vibration data associated with the vehicle. A processor captures and uses the data to determine depth of cut and blade wear during grinding. An output device is coupled to the processor, and the processor captures the data and displays on the output device, during grinding operations, at least one of the parameters selected from the group consisting of distance traveled, area of roadway ground, volume of material removed, abrasive cost per unit area of surface ground, vehicle speed, grinding head rpm, vibration, depth of cut, coolant pressure, coolant inlet temperature, coolant outlet temperature, blade wear, and combinations thereof.

In another aspect of the invention, an apparatus for grinding concrete roadways includes a ground engaging means for traveling along a roadway in a direction of movement, the ground engaging means supporting a grinding means thereon.

The grinding means has a central axis and a plurality of circular blades spaced co-axially thereon, each blade having a plurality of circumferentially spaced abrasives. An engine means is configured to drive the grinding means. The grinding means is displaceable to engage and grind the roadway at a grinding zone during the travel. A grinding monitoring system includes first displacement sensing means for capturing, during the travel, first distance data associated with a distance between a reference level and a location on the roadway ahead of the grinding zone in the direction of movement. The grinding monitoring system also includes second displacement sensing means for capturing, during the travel, second distance data associated with a distance between the reference level and a location on the roadway behind the grinding zone in the direction of movement. Processing means is provided for capturing and using the first and second distance data to determine depth of cut during grinding operations.

In a further aspect of the invention, a method for grinding concrete roadways includes operating a ground engaging vehicle to travel along a roadway in a direction of movement, and to rotationally drive a grinding head having a plurality of circular blades spaced co-axially on a central axis, each blade having a plurality of abrasives circumferentially spaced thereon. The grinding head is displaced to engage and grind the roadway at a grinding zone during the travel. The method also includes operating a grinding monitoring system including a first displacement sensor to generate, during the travel, first distance data associated with a distance between a reference level and a location on the roadway ahead of the grinding zone in the direction of movement. A second displacement sensor generates, during the travel, second distance data associated with a distance between the reference level and a location on the roadway behind the grinding zone in the direction of movement. A processor captures and uses the first and second distance data to determine depth of cut during grinding operations. The method also includes generating, during the foregoing operations, at least one of the parameters selected from the group consisting of distance traveled, area of roadway ground, volume of material removed, abrasive cost per unit area of surface ground, vehicle speed, grinding head rpm, vibration, depth of cut, coolant pressure, coolant inlet temperature, coolant outlet temperature, blade wear, and combinations thereof.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1A is a schematic elevational view of a roadway grinding machine on which an embodiment of the present invention is installed;

FIG. 1B is a perspective view, on an enlarged scale, with portions broken away, of a portion of the roadway grinding machine and installation of FIG. 1A; and

FIGS. 2 and 3 are graphical displays of outputs generated by the embodiment of FIGS. 1A and 1B.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable one to practice the invention, and other embodiments will be apparent in light of this disclosure. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Briefly, embodiments of the present invention include a monitoring system capable of capturing information on the state of roadway grinding operations and using the information to generate output (e.g., during grinding or “in-process”) that may be used by the operator of the roadway grinding machine to maintain or optimize grinding performance. These embodiments may not only assist the operator in controlling the grinding process, but may also benefit the abrasive product supplier and the contractor. The abrasive product manufacturer, for instance, may use information on usage and performance of the grinding wheels to properly price the abrasive product, and to improve the design (performance) of these products for particular grinding operations. Similarly, the contractor may use information on machine usage to facilitate job quoting to prospective customers.

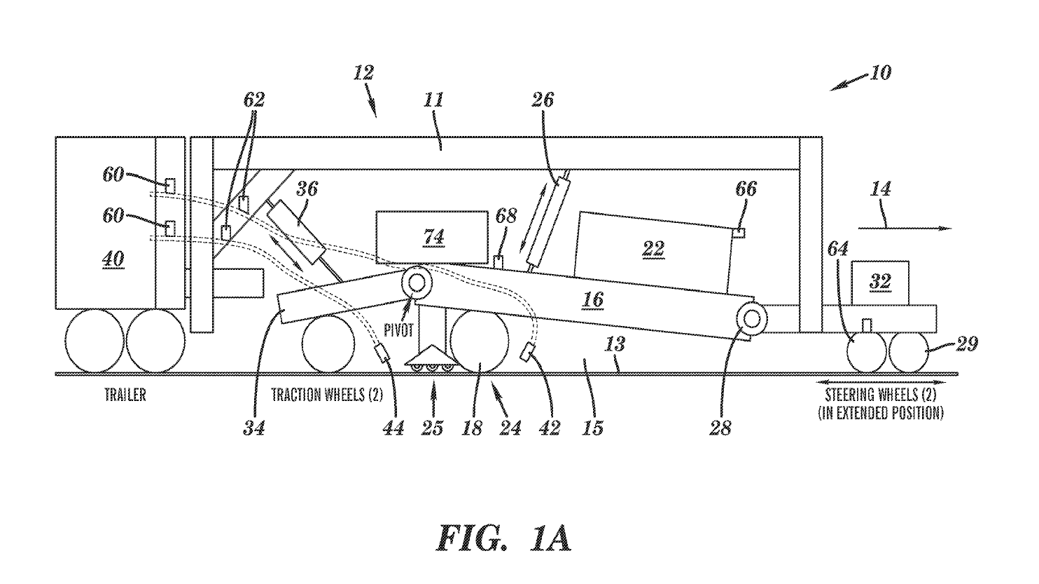

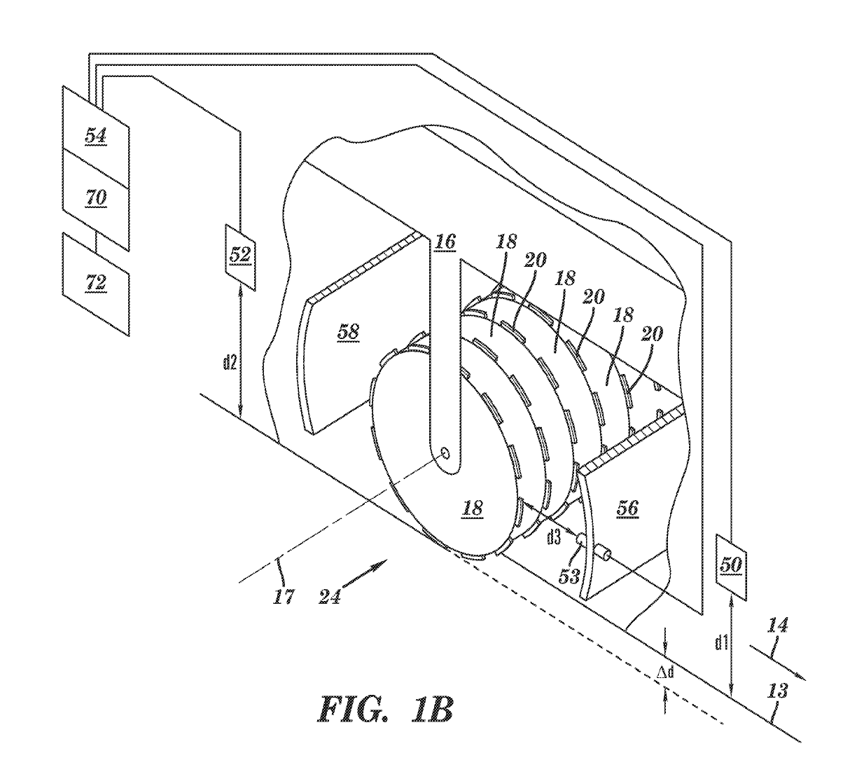

Particular embodiments include a system that automatically measures, records, analyzes and reports key operational and performance parameters in roadway grinding applications. For ease of discussion, embodiments of the present invention are shown and described with respect to conventional roadway grinding operations, using a roadway grinding machine 12 supporting a plurality of blades 18. It should be understood, however, that embodiments of the invention may be used in connection with substantially any grinding and/or cutting operation effected upon a roadway, tarmac, or other vehicle supporting surface, by one or more vehicularly supported grinding and/or cutting blades.

Where used in this disclosure, the term “axialu when used in connection with an element described herein, refers to a direction substantially parallel to axis 17 of a blade 18 when installed on grinding machine 12 as shown in FIGS. 1A and 1B. The term “in-processu and/or “real-timeu refers to the capture and processing of events as a roadway grinding process proceeds, e.g., to provide feedback during on-going operations.

Referring now to FIGS. 1A-4, embodiments of the present invention will be more thoroughly described. As shown in FIGS. 1A and 1B, a system 10 of the present invention may be used in conjunction with a roadway grinding machine 12 in the form of a ground engaging vehicle configured to travel along a roadway 13 in a direction of movement 14. Exemplary vehicles include a main frame 11 and a grinding wheel frame 16 configured to support a grinding head 15 along a grinding head axis of rotation 17. Grinding head 15 includes a plurality of circular blades 18 (FIG. 1A) spaced co-axially thereon. The blades 18 may be constructed in any manner suited to the particular grinding operation. In typical embodiments, blades 18 are relatively thin grinding wheels, each including a steel core with a plurality of metal-bonded abrasive (e.g., superabrasive including natural or synthetic diamond, PCD or CBN) segments 20 spaced circumferentially thereon. The blades are typically about 14 in (35 cm) in diameter and 0.2 in (0.5 cm) or 0.6 in (1.5 cm) wide, though substantially any size blades may be used. In typical embodiments, 170 to 280 blades may be mounted along a single axis 17, though greater or fewer blades may be used depending on needs dictated by particular grinding applications. An engine 22 (typically 300 to 750 hp) drives grinding head 16 about axis 17.

The grinding head 16 is displaceable, e.g., vertically, relative to vehicle 12, to engage and grind roadway 13 at a grinding zone 24, as the vehicle travels along the roadway in direction 14. In the exemplary embodiment shown, this displacement may be effected and controlled by adjusting conventional depth wheel assemblies 25 in combination with pressure applied by hydraulic cylinders 26. Wheel assemblies 25 and cylinders 26 may be actuated to raise and lower grinding head 15 by rotating grinding wheel frame 16 about pivot 28, to achieve a desired depth of cut. In typical applications, a depth of cut (d) of ⅛ in (0.3 cm) to 1 in (2.5 cm) may be achieved at rate of about 15 ft/min (4.6 m/min) over the roadway (i.e., in direction 14).

Other components of vehicle 12 include steering wheels 29, and traction (drive) wheels 30 driven in a conventional manner by a drive engine 32. As shown, traction wheels 30 are pivotably supported by a traction frame 34 which may be pivoted by hydraulic cylinder 36 to apply downward force as desired to increase traction of the wheels 30. In various embodiments, a coolant (e.g., water) tank 40 may be coupled to nozzle and collector assemblies 42, 44, which respectively apply coolant to, and collect used coolant from, grinding zone 24 in a conventional manner. An example of a roadway grinding machine of the type described herein, and to which embodiments of the present invention may be readily applied, is known as the Boart-Longyear PC5000B.

Turning now to FIG. 1B in particular, monitoring system 10 includes one or more first displacement sensors 50 (e.g., ultrasonic sensors supported by vehicle 12) configured to detect the distance d1 between a predetermined reference level (e.g., on main frame 11) and a location on roadway 13 ahead of grinding zone 24 in the direction of movement. Similarly, one or more second displacement sensors 52 are disposed to detect the distance d2 between a predetermined reference level and a location on roadway 13 behind grinding zone 24 in the direction of movement. Sensors 50 and 52 are communicably coupled to a processor 54, such as provided by a personal computer or hand-held device such as a PDA (Personal Digital Assistant) or Smart phone. Such communication may be provided in any suitable manner, e.g., by wire or wirelessly. Processor 54 is configured to capture and use the distance data d1, d2, to determine the depth of cut d during grinding operations.

In particular embodiments, this depth of cut information is provided by four ultrasonic displacement sensors (e.g., a pair of sensors 50, 52 at opposite ends of axis 17 to provide depth of cut information at both ends of grinding head 16). An algorithm may use this information, together with data on the positions of the sensors with respect to each other and the machine, to calculate the depth of Δd.

The depth of cut Ad determined in-process, i.e., while grinding is being performed, to provide in-process feedback to the machine operator, and/or automatically to the machine itself (such as by use of suitable electronic controls). This feedback may thus be used to adjust the height of grinding head 15 as the grinding operation progresses.

In light of the instant disclosure, the reader will recognize that in order to provide desired levels of measurement accuracy, the depth of cut apparatus may be calibrated from time to time. This may be accomplished, for example, by placing the grinding head 18 into a known depth of cut position, e.g., by lowering the grinding head 18 to contact a ground (or pre-ground) portion of the roadway 13. With the machine 10 stationary, a calibration routine may then be executed, e.g., by processor 54, in which the user is prompted to enter the known depth of cut position (e.g., zero, if head 18 is resting on an uncut portion of roadway). This routine may then correlate the known depth to the various measurements captured by the system 10, such as the output of sensors 50, 52, the angular position of the frame 16 (as may be determined by depth wheel assemblies 25 and hydraulic cylinders 26), and the information provided by sensors 53 with respect to the axis of the grinding wheel 18.

System 10 may optionally include one or more third displacement sensors 53 (e.g., ultrasonic sensors) configured to detect, during grinding operations, the distance d3 between an outermost circumference of at least one of the blades 18 and a predetermined position relative to axis 17. For example, as shown, sensors 53 may be disposed on wheel guard portions 56, 58, which are supported by frame 16 at a predetermined distance(s) from axis 17. Sensor(s) 53 are communicably coupled to processor 54, which captures the distance d3 and calculates blade wear associated with the grinding operations.

In particular embodiments, ultrasonic sensors 53 are placed at opposite (axial) ends of grinding head 15, e.g., on guard 56, and may be protected from debris by additional manually operated guards (not shown). For example, in the event such additional guards are used, sensors 53 may be actuated once grinding operations have been halted and the guards are opened.

Alternatively, such as when grinding relatively soft materials less likely to damage the sensors, the additional guards may not be used, or may simply be left open to enable use of sensors 53 during grinding. Each of the sensors 53 may generate d3 distance data which is then captured and converted by processor 54 into head diameter for both ends (i.e., the left and right sides) of grinding head 15.

Referring back to FIG. 1A, as further options, pressure sensors 60 and/or temperature sensors 62 may be coupled to the coolant supply and collection means, to detect the pressure and/or temperature of coolant flowing to and from nozzles and collectors 42, 44. A vehicle speed sensor 64, engine speed sensor 66, and/or vibration sensor 68 may also be disposed to detect vehicle speed, engine speed, and vibration data (e.g., of grinding head 15) during grinding operations.

While the data captured in-process may, in various embodiments, be outputted to a user or operator in-process, such data may also be stored, e.g., in non-volatile memory 70 or other data historian database associated with processor 54, and outputted after grinding operations have been completed, such as discussed in greater detail hereinbelow. In this manner, data from various grinding operations may be aggregated, such as to facilitate compilation of detailed historical reporting and analysis.

In particular embodiments, vehicle speed sensors 64, for example, may include proximity sensors disposed to sense the presence of targets spaced circumferentially along the hub of a vehicle wheel 29. The rotational rate of wheel 29 may then be calculated by measuring and analyzing the time between voltage pulses generated as each target moves past the sensor. By considering the radius of the wheel, this rotational rate may be converted to the speed of the machine 12 along roadway 13.

Moreover, the direction of motion may be determined in any convenient manner, such as through the use of dedicated sensors {not shown) configured to determine the orientation of steering wheels 29 relative to frame 16. Alternatively, such as in the event multiple steering wheels 29 are laterally spaced from one another, the direction of motion may be determined by analyzing the sequence of pulses from sensors associated with steering wheels 29 disposed on opposite {e.g., left and right hand) sides of machine 12.

Vibration sensor 68 may include an accelerometer mounted at any suitable location on the grinding wheel frame 16 as shown. The absolute or relative amount of acceleration or displacement due to vibration may be captured by processor 54 and recorded by historian 70. Processor 54 may then perform a Fourier or other analysis of the vibration signal data, such as to isolate dominant vibration frequencies and/or to otherwise relate the vibration data to factors such as severity of the grind, head imbalance, bearing problems, etc.

Engine speed sensor 66 may include any suitable device or system capable of generating an output corresponding to engine rpm. In some embodiments, a proximity detector may be disposed in proximity to engine 22 or to grinding head 15 to generate a pulse when a circumferentially mounted target rotates past it. Alternatively, the Electronic Control Unit (ECU) commonly associated with engine 22 may be communicably coupled to processor 54 to supply engine rpm and/or other data such as engine power, etc.

The data generated from any of the aforementioned sensors may be captured by processor 54 in the manner described hereinabove with respect to sensors 50, 52, 53, and stamped by the processor with the time and date of acquisition. This data may then be outputted by processor 54 in-process, (e.g., to an optional user interface 72, such as an LCD touch screen) for use by the machine operator (or automatically by the machine itself) as grinding progresses.

While the various sensors, processor 54, historian 70 and optional user interface 72 may be disposed on vehicle 12, any one or more of these components may be disposed remotely from the vehicle. For example, various components of system 10, e.g., sensors, processor, user interface/display, etc., may be wirelessly coupled to one another, e.g., using Wi-Fi (802.11x), cellular (e.g., GPRS or GSM), and/or Bluetooth® (Bluetooth Sig, Inc., Bellevue Wash.) wireless connectivity. Such wireless connectivity may be used to place various components, including one or more of processor 54, database 70, and user interface 72 either on vehicle 12 (e.g., within operator station 74) or remotely, such as at a jobsite office or within a portable device (e.g., PDA or Smart Phone, etc.).

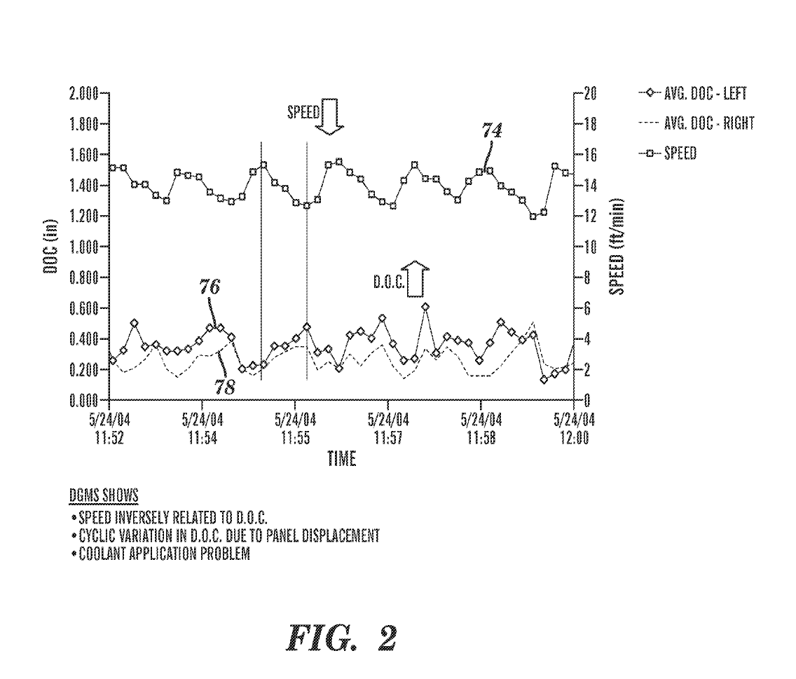

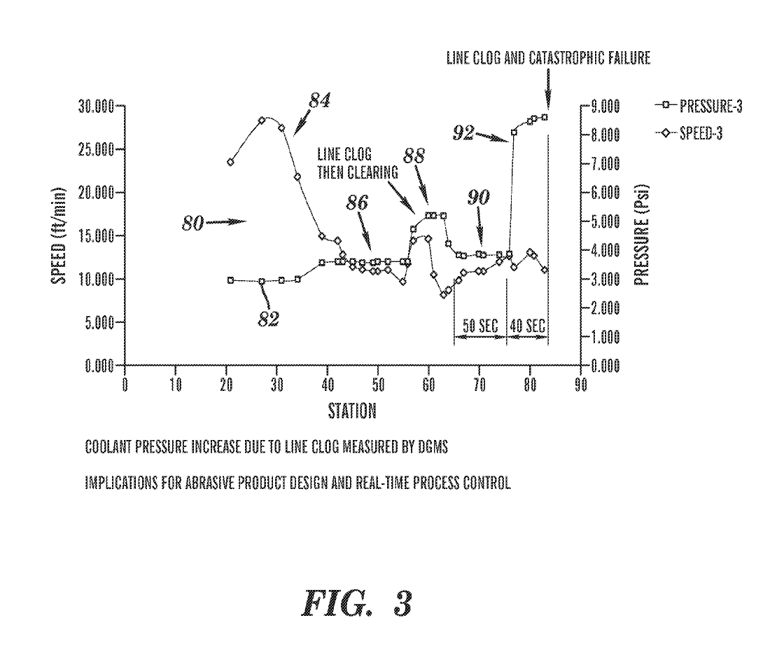

Referring to FIGS. 2 and 3, processor 54 and user interface 72 may be configured to display any of various parameters obtained or derived from the various captured sensor data. Distance traveled, area of roadway ground, volume of material removed, abrasive cost per unit area of surface ground, vehicle speed, grinding head rpm, grinding head vibration, depth of cut, coolant pressure, coolant inlet temperature, coolant outlet temperature, blade wear, and combinations thereof, may all be displayed, e.g., as a function of time, by interface/screen 72.

For example, as shown in FIG. 2, vehicle speed is plotted as a function of time at 74, while depth of cut on opposite (axial) ends of grinding head 15 is shown as a function of the same time scale at 76, 78. By such a display, a user can readily ascertain that in this instance, with other variables remaining constant, the depth of cut varies inversely with the speed of vehicle travel along the roadway.

As shown in FIG. 3, vehicle speed is plotted as a function of time at 80, while coolant pressure is also plotted at 82 as a function of the same time scale. This display shows an increase in coolant pressure attributable to a clog in the coolant line at 84, followed by clearing at 86, a subsequent clog and clearing respectively at 88 and 90, followed by a catastrophic line clog at 92.

Examples of additional plots include the amount of abrasive remaining on grinding head 15, based on the head specification and measurement of wheel diameter. The abrasive cost per square yard of surface ground, which is a conventional measure of project costs, may then be calculated. Other parameters, such as the surface area and volume of material removed over a given time period, may also be calculated.

A representative embodiment of the invention having been described, the following is a description of the operation thereof.

Monitoring system 10 may automatically start up and stand by for process measurement upon starting engine 22. Processor 54 then turns on and loads a suitable data acquisition program (e.g., LabView®, National Instruments Corporation, Austin, Tex.) and the array of various sensors is powered. The machine operator may then input setup information, such as project data and location on the roadway, which is then stored in database 70. The processor 54 continuously monitors the signals from the depth of cut sensors 50, 52. When sensors 50, 52 indicated that grinding head 15 has been lowered below a user-defined position, the data acquisition program automatically transitions from data entry mode, which permits the user to input information, to data collection mode, where sensor measurements are captured and calculations are made and stored in database 70. The frequencies of data sampling and recording to the database 70 may be defined by the user. During data collection (e.g., “in-process”), various parameters such as the depth of cut d, vehicle speed over ground, water pressure, relative vibration level, and/or various engine parameters such as engine speed and percent engine load, etc., may be displayed. Data entry and output may be provided with a user interface 72 such as a touch screen LCD mounted at operator station 74 or on a user's PDA or Smart phone. The acquisition of data and the recording of information to database 70 continues until grinding head 15 is raised above the user-defined threshold.

Optionally, information related to operational efficiency of vehicle 12 may also be gathered. For example, upon system startup, the machine operator may be prompted to enter a reason corresponding to the previous shutdown of the machine. Idle time may also be recorded in the database.

When engine 22 is turned off, power may be maintained to processor 54, which recognizes the turning off of an ignition switch (e.g., due to a signal sent via a relay) as initiation.

of machine shutdown. A connection to a wireless network may then be made, such as via a wireless modem card associated with processor 54, by which a data file stored in database 70 may be wirelessly transmitted, e.g., to a list of e-mail recipients for remote storage. The processor 54 (e.g., computer) may then automatically shut down once the data has been sent.

The data may be analyzed by processor 54 prior to shut down, and/or remotely by a recipient of the aforementioned data transmission. An analysis program, e.g., written in the Microsoft® Excel® (Microsoft Corporation, Redmond, Wash.) spreadsheet application, may read the database file(s) generated by system 12 and generate various plots, as described hereinabove, that provide the user with insight into the grinding operations either as they occur, or after operations have been concluded.

The following illustrative example is intended to demonstrate certain aspects of the present invention. It is to be understood that this example should not be construed as limiting.

### EXAMPLE

A system 10 was fabricated substantially as shown and described hereinabove. The roadway grinding machine was a Boart-Longyear PC5000B. Processor 54, memory 70 and user interface 72 were provided by a Wintel personal computer a notebook computer having an Intel® (Intel Corporation) processor running a Windows (Microsoft Corporation) operating system). The following sensors were used.
Depth of Cut Sensors 50, 52:
   Migatron RPS-401 ultrasonic displacement transducers (4)
Grinding Head Diameter sensors 53:
   Migatron RPS-401 ultrasonic displacement transducers (2)
Steering Wheel Motion (speed sensors 64):
   Efector IGC206 inductive proximity sensor (2)
Engine RPM sensor 66 (grinding wheel head rpm sensor):
   Efector IGC206 inductive proximity sensor
Machine Vibration sensor 68:
   Kistler 5127813 coupler and 8774A50 accelerometer
Cooling Water Pressure sensor 60:
   Omega PX303-050G10V
Cooling Water Temperature sensor 62:
   Omega fine-wire thermocouple (inlet & outlet temperature measurement)

The above-described embodiments provide a monitoring system capable of capturing information on the state of roadway grinding operations and using the information to generate output “in-processu that may be used to maintain or optimize grinding performance. These embodiments may not only assist in controlling the grinding process, but may also benefit the abrasive product supplier and the contractor. The abrasive product manufacturer may use information on usage and performance of the grinding wheels to properly price the abrasive product, and/or to improve the design (performance) of these products for particular grinding operations. The contractor may use information on machine usage to facilitate job quoting.

Although embodiments of the invention have been shown and described in connection with roadway grinding operations, it will be apparent in light of this disclosure that the monitoring system hereof may be used with nominally any grinding or cutting operations, using one or more blades, without departing from the spirit and scope of the present invention.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly-to be regarded in an illustrative rather than restrictive sense.

Having thus described the invention, what is claimed is:

1. A roadway grinding system, comprising:
a frame;
a first cutting blade disposed within the frame, the first cutting blade comprising:
a core; and
a plurality of abrasive segments spaced apart from each other on the core; and
a first sensor disposed on the frame and configured to detect blade wear as a change in the distance between an outermost circumference of the first cutting blade and a predetermined distance.

2. The roadway grinding system of claim 1, further comprising:
a second cutting blade disposed within the frame, the second cutting blade comprising:
a core; and
a plurality of abrasive segments spaced apart from each other on the core.

3. The roadway grinding system of claim 2, further comprising a second sensor disposed on the frame and configured to detect blade wear as a change in the distance between an outermost circumference of the second cutting blade and a predetermined distance.

4. The roadway grinding system of claim 3, wherein the first cutting blade and the second cutting blade are configured to conduct a grinding operation that includes grinding a roadway, cutting a roadway, or a combination thereof.

5. The roadway grinding system of claim 4, wherein at least one of the first sensor and the second sensor is configured to detect a change in distance during the grinding operation.

6. The roadway grinding system of claim 4, further comprising a processor coupled at least one of the first sensor and the second sensor, wherein the processor is configured to calculate a blade wear associated with the grinding operation.

7. The roadway grinding system of claim 5, wherein the processor is configured to convert the distance into a grinding wheel diameter and the blade wear is at least partially based on the grinding wheel diameter.

8. The roadway grinding system of claim 1, further comprising one or more additional sensors selected from the group including a pressure sensor, a temperature sensor, a displacement sensor, a vehicle speed sensor, a vibration sensor, and an engine speed sensor.

9. The roadway grinding system of claim 8, further comprising a processor, wherein the processor is configured to aggregate data from the first sensor and one or more of the additional sensors and to compile historical reports associated with one or more grinding operations.

10. The roadway grinding system of claim 9, wherein the processor is configured to determine one or more of the following: distance traveled, area of roadway ground, volume of material removed, abrasive cost per unit area of surface ground, vehicle speed, grinding head speed, grinding head vibration, depth of cut, coolant pressure, coolant inlet temperature, coolant outlet temperature, and cutting blade wear.

11. The roadway grinding system of claim 1, wherein the core comprises a metal material.

12. The roadway grinding system of claim 10, wherein the core comprises steel.

13. The roadway grinding system of claim 1, wherein each of the abrasive segments comprises a metal-bonded abrasive segment.

14. The roadway grinding system of claim 12, wherein each of the abrasive segments comprises a superabrasive.

15. The roadway grinding system of claim 13, wherein the superabrasive is selected from the group including natural diamond, synthetic diamond, polycrystalline diamond (PCD), and cubic boron nitride (CBN).

16. The roadway grinding system of claim 3, wherein the first cutting blade is disposed at first end of a grinding head and the second cutting blade is disposed at a second end of the grinding head.

17. The roadway grinding system of claim 16, wherein the first sensor is located near the first end of the grinding head and the second sensor is located near the second end of the grinding head.

18. The roadway grinding system of claim 17, wherein the first sensor is configured to detect a change in a first head diameter.

19. The roadway grinding system of claim 18, wherein the second sensor is configured to detect a change in a second head diameter.

20. The roadway grinding system of claim 19, further comprising a processor, wherein the processor is configured to determine a first blade wear rate associated with the first end of the grinding head and a second blade wear rate associated with the second end of the grinding head, wherein the first blade wear rate is at least partially based on the change in the first head diameter and the second blade wear rate is at least partially based on the change in the second head diameter.
